(19) United States
(12) Patent Application Publication
(10) Pub. No.: US 2008/0013882 A1
(43) Pub. Date: Jan. 17, 2008

(54) OPTICAL COUPLER WITH STABILIZED COUPLING RATIO

(75) Inventors: Shih-Jung Chang, Taipei City (TW); Yin-Chieh Huang, Taipei County (TW); Chi-Yu Ni, Taipei (TW); Yung-Jui Chen, Ellicott City, MD (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/463,894

(22) Filed: Aug. 11, 2006

(30) Foreign Application Priority Data
Jun. 29, 2006 (TW) 95123485

(51) Int. Cl. G02B 6/26

(52) U.S. Cl. 385/15

(57) ABSTRACT

An optical coupler is provided, which includes at least one first-type delay part having a delay quantity; at least one second-type delay part having a basic delay quantity and an adjustable delay quantity; and a plurality of optical splitting units. The plurality of optical splitting units is connected to the first-type delay part and the second-type delay part between an input end and an output end, for example, connected in a cascade manner, so as to obtain a stable effective coupling ratio. Alternatively, any desired stable effective coupling ratio may also be obtained by a set of the adjustable delay quantity.

### CROSS-REFERENCE TO RELATED APPLICATION

This application claims the priority benefit of Taiwan application serial no. 95123485, filed Jun. 29, 2006. All disclosure of the Taiwan application is incorporated herein by reference.

### BACKGROUND OF THE INVENTION

1. Field of Invention

The present invention relates to an optical splitting technique, and more particularly to an optical coupler with a stabilized coupling ratio.

2. Description of Related Art

In daily life, the information exchange is dense, and optical communication is one of the main communication manners. Splitter is one of the important devices in optical communication, and has been widely applied in dense wavelength division multiplexing (DWDM) systems and devices, such as add/drop multiplexer, interleave filter and thermo-optical switch. The splitter is mainly used for splitting light and wave. Generally, a directional coupler (DC) is usually adopted as the basic architecture, which is further, for example, a 3 dB optical coupler with a coupling ratio of 50%:50%.

FIG. 1 is a schematic view of the structure of a conventional 3 dB optical coupler. Referring to FIG. 1, the optical coupler comprises two optical arms (or optical waveguides), two input ends 10, 12 and two output ends 16, 18. The two optical arms have a coupling portion 14. Light is input from either of the input ends 10, 12 to pass through the coupling portion 14, and the light energy is coupled from one optical arm to the other. As such, the input light is split into two light quantities according to the coupling ratio of the coupling portion 14, and output from the output ends 16, 18 simultaneously. As for the 3 dB optical coupler, the coupling ratio κ thereof is 50%:50%, so the input light is split into two halves output from the output ends 16, 18. That is to say, the coupling ratio determines the optical splitting power.

However, besides depending on the design parameter, the coupling ratio may also be changed by errors in the fabrication process. For example, if the coupling ratio has an error of 5%, the optical splitting power is changed into 0.475:0.525. In other words, it can hardly meet the design requirement for the device unless the processing equipment is perfect.

The error on the length of the optical waveguide of the DC caused by the fabrication process can be compensated by external heating; however, the error on the coupling ratio still cannot be eliminated effectively. Therefore, the conventional splitter always has large errors on design and practical operation. If the splitter is applied to other devices, the prospected characteristics of the devices may be affected. However, splitters having different coupling ratios have been widely applied in DWDM devices. Therefore, it is a basic and important task for manufacturers or designers to search for an optical coupler which can be used in a planar optical waveguide device and can increase the process tolerance.

U.S. Pat. No. 6,735,358 provides a solution. FIG. 2 is a schematic view of the architecture of a conventional optical coupler. Referring to FIG. 2, the conventional optical coupler comprises three optical splitting units 100, 110, 112. Each optical splitting unit, such as optical splitting unit 100, is constituted by three coupling units 102 and two delay units 104, wherein the three coupling units 102 have different coupling ratios. Two output ends 106 and 108 of the first optical splitting unit 100 are respectively input into the optical splitting units 110 and 112. As such, when the process has an error of 10%, the signal ratio still reaches 20 dB. However, there is no solution for how to improve the optical splitting power and thereby increasing the process tolerance.

Further, FIG. 3 is a schematic view of the architecture of another conventional optical coupler. FIG. 3 is a method provided by Japanese Patent Application NO. 20010241370. The optical coupler comprises four optical splitting units having the same coupling ratio κ and three delay units. The three delay units respectively have characteristic delay quantities of λ/4, ΔL, −λ/4, wherein ΔL is adjustable. Due to the set of ΔL, together with the specific characteristic delay quantities of λ/4 and −λ/4, the conventional design can reduce the impact of the process error on the output power.

Though the above designs of the conventional optical coupler have their own designing effect, how to improve the design of the optical coupler still needs to be researched and developed.

### SUMMARY OF THE INVENTION

The present invention provides an optical coupler, which can at least improve the effect of the splitter to the process tolerance, and can, for example, provide a stabilized coupling ratio.

The present invention provides an optical coupler, which comprises at least one first-type delay part having a delay quantity; at least one second-type delay part having a basic delay quantity and an adjustable delay quantity; and a plurality of optical splitting units. The plurality of optical splitting units is cascaded to the first-type delay part and the second-type delay part between an input end and an output end, so as to obtain a stable effective coupling ratio. Alternatively, any desired stable effective coupling ratio may be obtained by a set of the adjustable delay quantity.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is a schematic view of the structure of a conventional 3 dB optical coupler.

FIG. 2 is a schematic view of the architecture of a conventional optical coupler.

FIG. 3 is a schematic view of the architecture of another conventional optical coupler.

FIG. 4 is a schematic view of the architecture of an optical coupler according to an embodiment of the present invention.

FIG. 5 is a variation curve of the effective coupling ratio κ_{eff} with the coupling ratio κ according to an embodiment of the present invention.

FIG. 6 is a variation curve of the effective coupling ratio κ_{eff} with the coupling ratio κ according to another embodiment of the present invention.

FIG. 7 is a schematic view of the architecture of an optical coupler according to another embodiment of the present invention.

FIG. 8 is an optical coupler based on FIG. 4.

FIG. 9 is an optical coupler based on FIG. 7.

### DESCRIPTION OF EMBODIMENTS

The present invention provides an optical coupler, for example, an optical coupler with a stabilized coupling ratio calculated and designed by mathematical matrix. The architecture of the device can maintain a simple design and increase the process tolerance, so as to be applied to optical waveguide processing techniques, for example, the processes of wave dividers such as add/drop multiplexer, interleave filter, thermo-optical switch and other possible applications. The present invention can also be applied to, for example, optical fibers or optical devices. Some embodiments are used below to illustrate, but not to limit, the present invention.

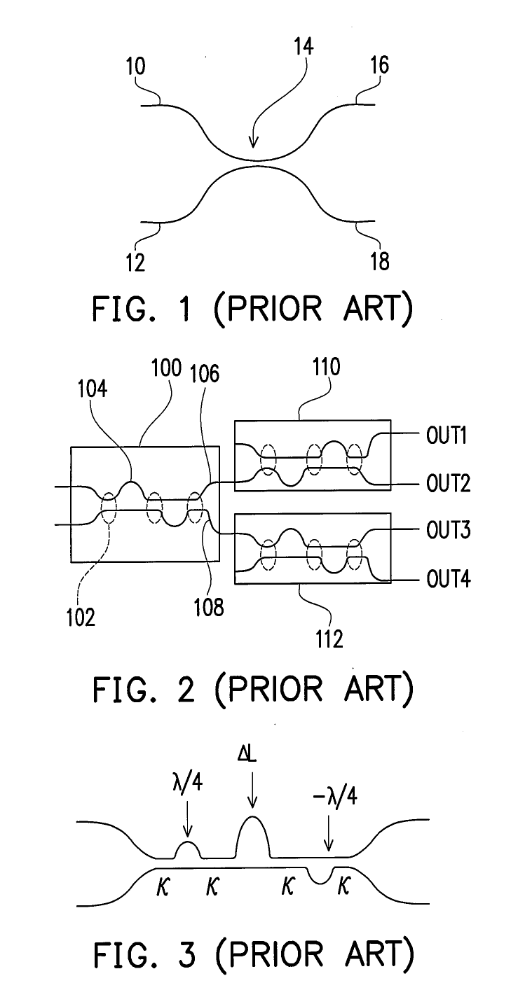

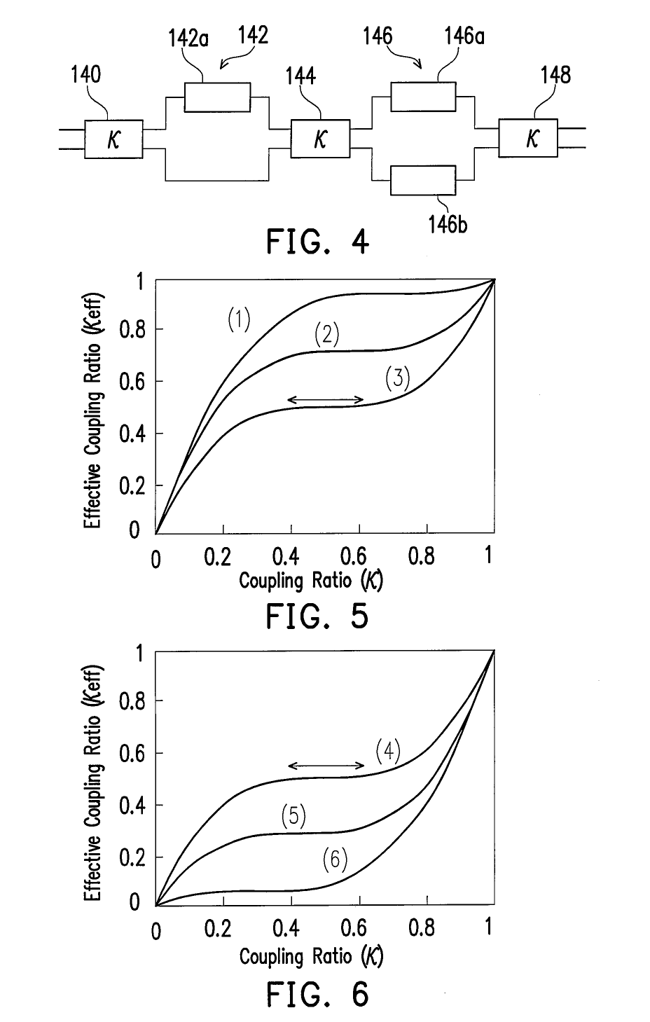

FIG. 4 is a schematic view of the architecture of the optical coupler according to an embodiment of the present invention. The input end of the optical coupler with a stabilized coupling ratio has an optical splitting unit 140. The structure of the optical splitting unit 140 is, for example, shown in FIG. 1, i.e., a DC. Of course, the optical splitting unit 140 can also be other optical splitting devices. The optical splitting unit 140 is connected to a first-type delay part 142. The first-type delay part 142 can be of, for example, a conventional delay structure, comprising two optical arms, wherein one optical arm has a delay portion 142a. In other words, the first-type delay part 142 has a delay quantity.

The first-type delay part 142 is subsequently cascaded to another optical splitting unit 144. The coupling ratio of the optical splitting unit 144 is, preferably, substantially the same as that of the optical splitting unit 140 or different as well. In the following embodiments, the aforementioned coupling ratios are identical as an example.

The optical splitting unit 144 is subsequently cascaded to a second-type delay part 146. The second-type delay part 146, for example, shown in FIG. 4, also comprises two optical arms. One of the two optical arms has a basic delay portion 146a, and the other has an adjustable delay portion 146b which can generate an adjustable delay quantity. The basic delay portion 146a is disposed in considering together with the delay portion 142a. The basic delay portion 146a is used to generate a basic delay quantity which is, for example, substantially the same as or different from the delay quantity of the delay portion 142a. The adjustable delay portion 146b is used to adjust the delay quantity, so as to achieve the overall stabilized effective coupling ratio. In other words, the total delay quantity of the second-type delay part 146 is generated by calculating the adjustable delay quantity and the basic delay quantity. Then, the second-type delay part 146 is subsequently cascaded to an optical splitting unit 148, wherein the optical splitting unit 148 is similar to the optical splitting units 140, 144 in structure, while the coupling ratios thereof can be substantially the same or different.

The output light signal of FIG. 4 can be represented by mathematical matrix. If the delay lengths of the delay portion 142a and the delay portion 146a are assumed to be λ/3, the calculation is made according to Formula (1):

$$[ \begin{matrix}{E}_{out 1} \\ {E}_{out 2}\end{matrix} ] = [ \begin{matrix}c & - js \\ - js & c\end{matrix} ] [ \begin{matrix}{e}^{- j \frac{2 π}{3}} & 0 \\ 0 & 1\end{matrix} ] [ \begin{matrix}c & - js \\ - js & c\end{matrix} ] [ \begin{matrix}{e}^{- j θ} & 0 \\ 0 & {e}^{- j \frac{2 π}{3}}\end{matrix} ] [ \begin{matrix}c & - js \\ - js & c\end{matrix} ] [ \begin{matrix}{E}_{i n 1} \\ {E}_{i n 2}\end{matrix} ] \qquad ( 1 )$$

wherein, Eᵢₙ₁ and Eᵢₙ₂ are input light field intensities, Eₒᵤ₁ and Eₒᵤ₂ are output light field intensities, 1 and 2 represent two waveguides of the input end and the output end. c=\sqrt{1−κ} and −js=\sqrt{j√κ} are transmission and coupling values of adjacent optical waveguides in the DC, and are also functions of the optical coupling ratio κ. θ=βΔL is the delay phase for setting the output intensity value of the light signal. β=2π/λ is propagation constant of the light signal, and ΔL is the length of the delay optical path. The whole optical coupler as shown in FIG. 4 has an effective coupling ratio κ_{eff} as shown by Formula (2):

$${κ}_{eff} = \frac{{\vert {E}_{out 2} \vert}^{2}}{{\vert {E}_{out 1} \vert}^{2} + {\vert {E}_{out 2} \vert}^{2}} . \qquad ( 2 )$$

The optical coupling ratio of the DC is generally related to the distance between adjacent optical waveguides, the width of the optical waveguide and the refractive index of the optical waveguide. Therefore, conventionally, some process errors may cause changes in the parameters, thus affecting the practical optical power output value. It can hardly meet the design requirement for the device unless the processing equipment is perfect.

However, according to the design of the present invention, based on the calculations of Formula (1) and Formula (2), if κL, for example, is λ/3, λ/4, λ/8, and the directional optical coupler is a 3 dB directional optical coupler, the changes of the effective optical coupling ratio κ_{eff} with the optical coupling ratio κ are shown by curves (3), (2), and (1) in FIG. 5. The three distribution curves also have a flat region, i.e., the stabilized region. In other words, in this stabilized region, the error of the optical coupling ratio κ, for example, caused during the process will not obviously change the effective optical coupling ratio κ_{eff}. In other words, it is estimated that the process tolerance range may reach approximately 21.6%, 24.9%, 31.1%. Further, even if the stabilized region is not taken into consideration, any value in the range of 0<κ_{eff}<1 can be obtained by adjusting the ΔL. Of course, the directions of the input end and the output end can be exchanged, and the result is the same, which may be applied in optical communication systems and devices. The existing optical waveguide and optical fiber devices have small propagation loss, for example, the propagation loss of silica waveguide is smaller than 0.01 dB/cm. The loss of the optical fiber devices is counted in kilometers, and thus the propagation loss of this structure may be omitted. Generally, the additional loss is not large.

Moreover, if the delay quantity of the delay portion 142a in FIG. 4 is set as 2λ/3, and the delay quantity of the basic delay portion 146a is set as λ/3, the similar calculation result is shown by curves (4), (5), (6) in FIG. 6, and the corresponding ΔL is λ/3, λ/4, λ/8. It is estimated that the process tolerance range may also reach approximately 21.6%, 18.2%, 12%.

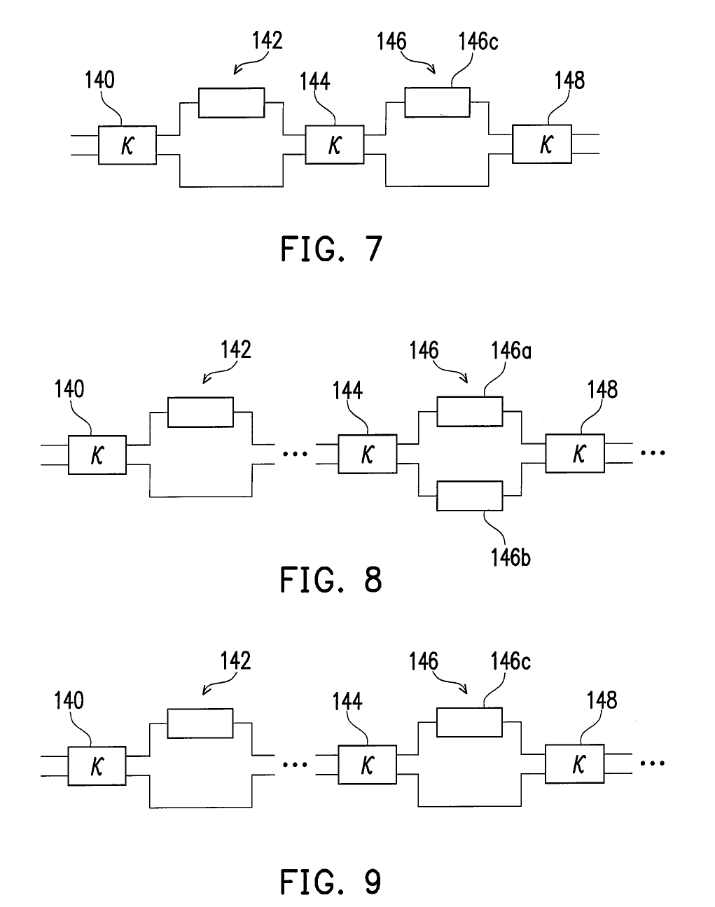

Furthermore, some modifications may be made according to the same mechanism of FIG. 4. FIG. 7 is a schematic view of the architecture of an optical coupler according to another embodiment of the present invention. Referring to FIG. 7, the difference between FIG. 7 and FIG. 4 is that, the basic delay portion 146a and an adjustable delay portion 146b in FIG. 4 are integrated to form another adjustable delay portion 146c. The adjustable delay portion 146c may comprise a base number of the delay quantity. If written in a mathematical matrix, the output light signal is shown by, for example, Formula (3):

$$[ \begin{matrix}{E}_{out 1} \\ {E}_{out 2}\end{matrix} ] = [ \begin{matrix}c & - js \\ - js & c\end{matrix} ] [ \begin{matrix}{e}^{- j \frac{2 π}{3}} & 0 \\ 0 & 1\end{matrix} ] [ \begin{matrix}c & - js \\ - js & c\end{matrix} ] [ \begin{matrix}{e}^{- j θ + j \frac{2 π}{3}} & 0 \\ 0 & 1\end{matrix} ] [ \begin{matrix}c & - js \\ - js & c\end{matrix} ] [ \begin{matrix}{E}_{i n 1} \\ {E}_{i n 2}\end{matrix} ] . \qquad ( 3 )$$

The features of FIG. 7 are the same as those of FIG. 4, and the details thereof will not be described herein. Further, according to the design of FIG. 4 and FIG. 7, further modifications can also be made according to practical requirements. FIG. 8 is an optical coupler based on FIG. 4. Referring to FIG. 8, the difference is that, the quantities of the first-type delay part 142 and the second-type delay part 146 are not limited to one. In other words, the number of the first-type delay part 142 is at least one, the number of the second-type delay part 146 is also at least one, and they are connected with each other by, for example, a plurality of DCs 140, 144, 148.

It should be noted that, the connecting manner is, for example, serial connection. However, if required, the connecting manner may also be one similar to a tree structure, not limited to the serial connection.

Moreover, FIG. 9 is an optical coupler based on FIG. 7. Similarly to FIG. 8, the quantities are not limited, but the structure of the second-type delay part 146 employs the design in FIG. 7.

In view of the above, the optical coupler of the present invention comprises at least one first-type delay part having a delay quantity; at least one second-type delay part having a basic delay quantity and an adjustable delay quantity; and a plurality of optical splitting units. The plurality of optical splitting units is connected to the first-type delay part and the second-type delay part between an input end and an output end, for example, connected in a cascade manner, so as to obtain a stable effective coupling ratio. Alternatively, any desired effective coupling ratio may be obtained by a set of the adjustable delay quantity, and the desired effective coupling ratio is, for example, an effective coupling ratio in the flat region. The present invention at least increases the tolerance for the process error.

In general, according to the present invention as described above, several options can be taken.

According to an embodiment of the present invention, in the above optical coupler, the plurality of optical splitting units is, for example, directional optical couplers or splitters.

According to an embodiment of the present invention, in the above optical coupler, a plurality of coupling ratios of the plurality of optical splitting units is, for example, substantially the same, or has different values.

According to an embodiment of the present invention, in the above optical coupler, the delay quantity of the first-type delay part and the basic delay quantity of the second-type delay part are, for example, substantially the same, or have different values.

According to an embodiment of the present invention, in the above optical coupler, for example, the number of the first-type delay part is one, the number of the second-type delay part is one, and the number of the plurality of optical splitting units is three.

According to an embodiment of the present invention, in the above optical coupler, for example, the number of the first-type delay part is several.

According to an embodiment of the present invention, in the above optical coupler, for example, the first-type delay part comprises two optical arms, and a length difference between the two optical arms is the delay quantity.

According to an embodiment of the present invention, in the above optical coupler, for example, the second-type delay part comprises a first optical arm and a second optical arm, wherein the first optical arm is used to generate the basic delay quantity and the second optical arm is used to generate the adjustable delay quantity.

According to an embodiment of the present invention, in the above optical coupler, for example, the second-type delay part comprises a first optical arm and a second optical arm, wherein the first optical arm does not have a delay quantity, and the second optical arm is used to generate a total delay quantity which is the sum of the basic delay quantity and the adjustable delay quantity.

According to an embodiment of the present invention, in the above optical coupler, for example, the number of the second-type delay part is one or several.

Though the present invention has been disclosed above by the preferred embodiments, they are not intended to limit the present invention. Anybody skilled in the art can make some modifications and variations without departing from the spirit and scope of the present invention. Therefore, the protecting range of the present invention falls in the appended claims.

What is claimed is:

1. An optical coupler, comprising:
at least one first-type delay part, having a delay quantity;
at least one second-type delay part, having a basic delay quantity and a adjustable delay quantity; and
a plurality of optical splitting units, used to connect the first-type delay part and the second-type delay part between an input end and an output end,
wherein a desired effective coupling ratio is obtained by a set of the adjustable delay quantity.

2. The optical coupler as claimed in claim 1, wherein the plurality of optical splitting units is directional optical couplers.

3. The optical coupler as claimed in claim 1, wherein the plurality of optical splitting units is splitters.

4. The optical coupler as claimed in claim 1, wherein a plurality of coupling ratios of the plurality of optical splitting units is substantially the same or has different values.

5. The optical coupler as claimed in claim 1, wherein the delay quantity of the first-type delay part and the basic delay quantity of the second-type delay part are substantially the same or have different values.

6. The optical coupler as claimed in claim 1, wherein the number of the first-type delay part is one, the number of the second-type delay part is one, and the number of the plurality of optical splitting units is three.

7. The optical coupler as claimed in claim 1, wherein the delay quantity of the first-type delay part is substantially λ/3, and the basic delay quantity of the second-type delay part is substantially λ/3.

8. The optical coupler as claimed in claim 1, wherein the delay quantity of the first-type delay part is substantially 2λ/3, and the basic delay quantity of the second-type delay part is substantially λ/3.

9. The optical coupler as claimed in claim 1, wherein the number of the first-type delay part is multiple.

10. The optical coupler as claimed in claim 1, wherein the first-type delay part comprises two optical arms, and a length difference between the two optical arms is the delay quantity.

11. The optical coupler as claimed in claim 1, wherein the second-type delay part comprises a first optical arm and a second optical arm, the first optical arm is used to generate the basic delay quantity, and the second optical arm is used to generate the adjustable delay quantity.

12. The optical coupler as claimed in claim 11, wherein the number of the first-type delay part is one.

13. The optical coupler as claimed in claim 11, wherein the number of the first-type delay part is multiple.

14. The optical coupler as claimed in claim 1, wherein the second-type delay part comprises a first optical arm and a second optical arm, the first optical arm does not have a delay quantity, and the second optical arm is used to generate a total delay quantity which is the sum of the basic delay quantity and the adjustable delay quantity.

15. The optical coupler as claimed in claim 14, wherein the number of the first-type delay part is one.

16. The optical coupler as claimed in claim 14, wherein the number of the first-type delay part is multiple.

17. The optical coupler as claimed in claim 1, wherein the number of the second-type delay part is one.

18. The optical coupler as claimed in claim 1, wherein the number of the second-type delay part is multiple.
